(19) United States
(12) Patent Application Publication
(10) Pub. No.: US 2021/0031333 A1
(43) Pub. Date: Feb. 4, 2021

(54) CLAMP ASSEMBLY

(71) Applicant: Swanstrom Tools USA Inc., Superior, WI (US)

(72) Inventors: Gary Hutchinson, Paralta, NM (US); Timothy W. Sheriff, Duluth, MN (US)

(21) Appl. No.: 16/945,318

(22) Filed: Jul. 31, 2020

Related U.S. Application Data
(60) Provisional application No. 62/881,663, filed on Aug. 1, 2019.

(51) Int. Cl. B25B 5/14; B25B 5/16

(52) U.S. Cl. CPC B25B 5/14; B25B 5/163

(57) ABSTRACT

A clamp assembly and method of use. Disclosed examples of the clamp assembly include an annular base, at least three movable fingers, a plurality of first finger fasteners, and a plurality of edge fasteners. The annular base defines an opening. A workpiece can be positioned in the opening. The movable fingers have first and second opposite end portions, and each of the movable fingers has substantially the same size and shape. Each first finger fastener pivotally couples the first end portion of one of the movable fingers to the base to enable movement of the movable finger in the opening. The first end portions of the movable fingers are equidistantly spaced from one another. Each edge fastener is coupled to the second end portion of one of the movable fingers and configured for movement between a clamping position and a release position.

### CROSS-REFERENCE TO RELATED APPLICATION

This application claims priority to Provisional Application No. 62/881,663, filed Aug. 1, 2019, which is herein incorporated by reference in its entirety.

### FIELD

Disclosed embodiments relate generally to clamps for clamping workpieces.

### BACKGROUND

Articles of personal adornment such as jewelry include small stampings that have designs sawed or pierced into them by hand with a jewelers' saw. In order to make a pair of identical components, two stamped discs can be glued or taped together, and a design is applied to one of the discs as a template for sawing or otherwise forming the design. The design can then be simultaneously sawed out on two disc-shaped workpieces.

Various holding mechanisms including manual holding mechanisms (i.e., a maker's fingers), as well as various tools, such as bench pins, pliers, and ring clamps, are employed to hold workpieces while a design is sawed out. Often these workpieces are quite small and difficult to be held securely and manipulated during sawing.

There remains a continuing need for improved mechanisms to hold workpieces. Such a holding mechanism should be capable of securely holding the workpiece and efficient to use. A holding mechanism that can be used with workpieces having ranges of sizes and shapes would be especially desirable.

### SUMMARY

Various inventive concepts disclosed herein relate to features for overcoming problems currently encountered using methods and tools according to more standard practice and may also provide greater ergonomic comfort for the person performing a forming method on a workpiece.

Disclosed examples include a clamp assembly that can be used with workpieces having ranges of sizes and shapes. The clamp assembly can securely hold the workpieces, and is efficient and effective to use. Examples of the clamp assembly comprise: a base defining an opening, wherein a workpiece can be positioned in the opening; a plurality of movable fingers including first and second opposite end portions, wherein the first end portion of each movable finger is adjustably coupled to the base such that the movable finger is angularly adjustable relative to the base and capable of extending into the opening; and an edge fastener coupled to the second end portion of each movable finger, wherein the edge fastener is configured to releasably engage the workpiece in the opening. In examples, each movable finger is substantially similar in size and shape. In examples, the base is annular in shape. In examples, each movable finger is arcuate in shape. Each edge fastener is adjustably attached to the associated movable finger for movement between a clamping position and a released position in examples. For example, each edge fastener can be threadedly attached to the associated movable finger. In examples, each edge fastener includes a friction enhancing member configured to enhance engagement with the workpiece. Examples include a plurality of friction enhancing members, wherein each friction enhancing member is associated with one of the movable fingers and is configured to enhance engagement between the movable finger and the workpiece. Examples include at least three movable fingers. Each movable finger is configured to project radially into the opening relative to the base, and to be rotated at least 45 degrees with respect to the base, in examples.

Disclosed examples include a clamp assembly, comprising: an annular base defining and opening, wherein a workpiece can be positioned in the opening; at least three movable fingers having first and second opposite end portions, wherein each of the movable fingers has substantially the same size and shape; a plurality of first finger fasteners, each first finger fastener pivotally coupling the first end portion of one of the movable fingers to the base to enable movement of the movable finger in the opening, and wherein the first end portions of the movable fingers are equidistantly spaced from one another; and a plurality of edge fasteners, each edge fastener coupled to the second end portion of one of the movable fingers and configured for movement between a clamping position and a release position. In examples, each movable finger is arcuate and has a radius of curvature substantially similar to a radius of curvature of the base. For example, the base and movable fingers can be sized and shaped to enable each of the movable fingers to overlay the base in a retracted position. In examples, each movable finger is arcuate and has a radius of curvature substantially similar to a radius of curvature of the base. A lip extends from a side of the base opposite the opening, and prevents movement of the movable arms beyond the base in examples. The edge fasteners are threadedly attached to the movable fingers for movement between the clamping and release positions in examples. Examples also include a plurality of friction enhancing members, wherein each friction enhancing member is associated with one of the movable fingers and is configured to enhance engagement between the movable finger and the workpiece.

Disclosed examples include patterning one or more workpieces using a clamp assembly including a frame defining an opening and a plurality of movable fingers extending from the frame into the opening, comprising: positioning the one or more workpieces in the opening of a frame; pivoting the movable fingers into engagement with the one or more workpieces; clamping the one or more workpieces to the movable fingers; and forming a pattern on the one or more workpieces while the one or more workpieces are clamped to the clamping assembly. Examples also include positioning a positioning guide in the opening of the frame; and positioning the one or more workpieces using the positioning guide before clamping the one or more workpieces to the movable fingers.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 shows an illustration of an example clamp assembly with a workpiece coupled to it, according to some embodiments.

FIG. 2 shows an illustration of a base of the clamp assembly, according to some embodiments.

FIG. 3 shows an illustration of a movable finger of the clamp assembly, according to some embodiments.

FIG. 4 shows an illustration of an edge fastener of the clamp assembly, according to some embodiments.

FIGS. 5A-5E illustrate various shapes of the workpieces, according to some embodiments.

FIG. 6 shows an example clamp assembly without the workpiece in the center, with movable fingers pointing radially inward, according to some embodiments.

FIG. 7 shows an example clamp assembly with movable fingers aligned with the edge of the base, according to some embodiments.

FIG. 8 shows an example clamp assembly with a workpiece with a pattern sawed out removably attached to the clamp assembly, according to some embodiments.

FIG. 9 shows a cross section of an example clamp assembly with two workpieces clamped to movable fingers, taken across line 9-9 in FIG. 8, according to some embodiments.

FIG. 10 shows an isometric view of the clamp assembly shown in FIG. 8, according to some embodiments.

FIG. 11 is an illustration of a centering tool in accordance with embodiments.

FIG. 12 is an illustration of the centering tool of FIG. 11 positioned in the clamp assembly, in accordance with embodiments.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

Various inventive aspects addressed herein relate to a clamp assembly for use with a workpiece where the clamp assembly is adjustable for use with any of a variety of different workpiece shapes and sizes. Examples of the clamp assembly are configured for use with workpieces in the form of thin discs of material (e.g., circular in profile, or of another shape) where the clamp assembly includes a plurality of movable fingers that can be adjusted to hold the workpieces by their edges. In examples, the plurality of movable fingers are pivotally attached to a frame or base of the clamp assembly through a plurality of finger fasteners, and the workpieces are removably attached to the movable fingers through a plurality of edge fasteners. Multiple workpieces can be attached to the clamp assembly at the same time, facilitating sawing or otherwise making identical patterns in the workpieces as part of a single operation.

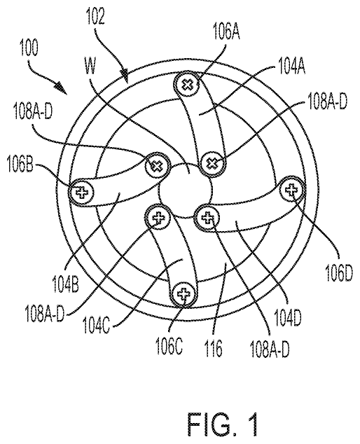

FIG. 1 is an illustration of an example clamp assembly 100 with a workpiece W coupled to it, according to some embodiments. As shown, the clamp assembly 100 includes a frame or base 102, a plurality of movable fingers 104A-104D mounted to the base 102, a plurality of finger fasteners 106A-106D for adjustably (e.g., pivotally) coupling the movable fingers 104A-104D to the base 102, and a plurality of edge fasteners 108A-108D for releasably coupling the workpiece W to the plurality of fingers 104A-104D. As will be subsequently described, the plurality of movable fingers 104A-104D are adjustable to accommodate a shape and size of the workpiece W. In some instances, components of the clamp assembly 100 could be made of various materials such as metal, aluminum, or any other materials.

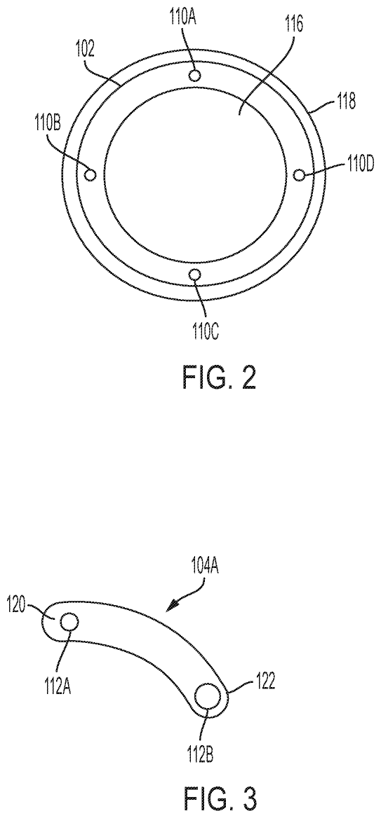

FIG. 2 is an illustration of the base 102 of the clamp assembly 100, according to some embodiments. The base 102 includes a plurality of base openings 110A-110D. The plurality of movable fingers 104A-104D may be pivotally mounted to the base 102 through the plurality of base openings 110A-110D. The base 102 also has a central opening 116. In some instances, the base 102 and/or the central opening 116 are annular or circular in shape. The base 102 further includes a raised lip 118 extending from the outer side of the base. The lip 118 can enhance the rigidity of the base 102, and can also constrain the movement of the fingers 104A-104D (e.g., by preventing the fingers from being able to rotate beyond the perimeter of the base). In some instances, the outer diameter of the base 102 is 6 cm and the inner diameter is 4.4 cm, and the raised lip may be 0.1 cm. The inner and outer diameters may vary based on the sizes of the workpieces. Accordingly, the size of the central opening 116 may vary as well relative to the inner and outer diameters.

FIG. 3 shows a first movable finger 104A of the plurality of movable fingers 104A-104D, according to some embodiments. As shown, each of the plurality of movable fingers 104A-D is optionally substantially similar in shape and size (e.g., within manufacturing tolerances, or to provide similar functionality), and thus each of the plurality of movable fingers 104A-104D is described collectively with reference to the first movable finger 104A. Although fingers of similar shape and size are described, it should also be understood that differing finger designs are contemplated. As shown in FIG. 1, there are four movable fingers, including the first movable finger 104A, a second movable finger 104B, a third movable finger 104C, and a fourth movable finger 104D. As an expedient, features of the other movable fingers are called out in the subsequent description with the same reference number as the first movable finger, but followed by a letter corresponding to that movable finger (e.g., a “C” where a feature of the third movable finger 104C is being called out that corresponds to a similar feature to that of the first movable finger 104A). Although four movable fingers are shown by way of example, any numbers are contemplated (e.g., two, three, seven, twelve, etc.). Additionally, although the movable fingers 104A-104D are each optionally substantially similar to one another, they may also vary in size and shape with respect to one another according to various alternative examples.

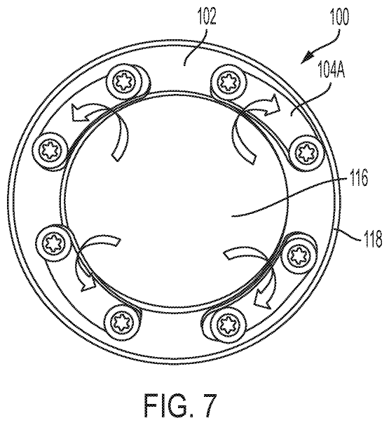

In the illustrated embodiments, the first movable finger 104A is arcuate in shape defining a radius of curvature Ra. In some examples, Ra is similar to the radius of curvature of the base 102 such that the first movable finger may be tucked or folded against the raised lip 118 of the base 102 in a relatively compact arrangement. In the illustrated example, the movable fingers 104A-104D can overlay the base 102 when the movable fingers are in retracted positions (e.g., as shown in FIG. 7). In addition, due to the similarity in radius and curvature, there is more overlap between the first movable finger 104A and the base 102, so that the base 102 provides more support for the movable finger 104A. In other embodiments, one or more, and optionally all, of the moveable fingers have other shapes (e.g., are straight).

The first movable finger 104A defines a first end portion 120 and a second end portion 122, the first end portion 120 being adjustably coupled to the base 102 such that the first movable finger 104A is angularly adjustable (e.g., pivotal) relative to the base 102. The first movable finger 104A further includes a first movable finger opening 112A and a second movable finger opening 112B. The first movable finger opening 112A is used to attach the first movable finger 104A to the base 102 through the finger fastener 106A on the first end 120. The second movable finger opening 112B is used to attach the workpiece W to the first movable finger 104A through the edge fasteners 108A on the second end portion 122.

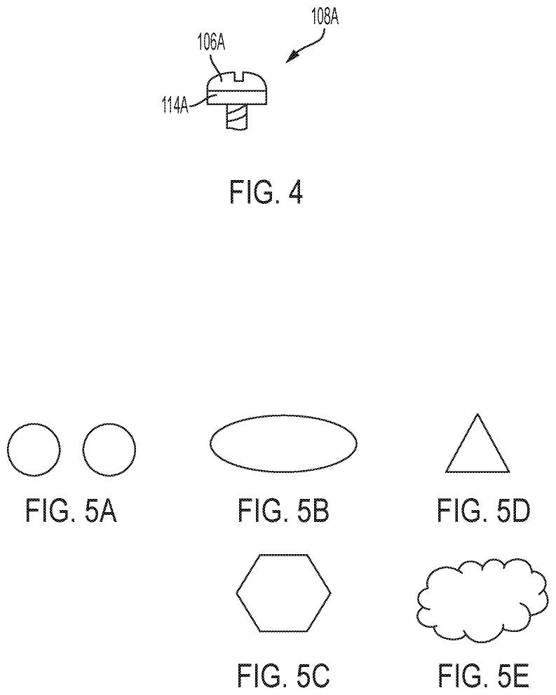

FIG. 4 is an illustration of an edge fastener 108A of the clamp assembly 100, according to some embodiments. The edge fastener 108A may further include a friction enhancing member 114A. The friction enhancing member 114A may be made of plastic, or any other material that enhances friction between the workpiece W and the edge fasteners 108A-108D. In some instances, the finger fastener 106A may be the edge fastener 108A without the friction enhancing member 114A, and the finger fastener 106A may be a screw with either male or female threading. In other instances, the finger fastener 106A may be a spring clip or adhesive. Other embodiments include other friction enhancing structures (e.g., on the second end 122 of the finger 104A) to enhance the friction between the workpiece W and the finger.

FIGS. 5A-5E are illustrations of various sizes and shapes of the workpiece W, according to some embodiments. The workpiece W could be circular in shape, or triangular, hexagonal, or of any other shape.

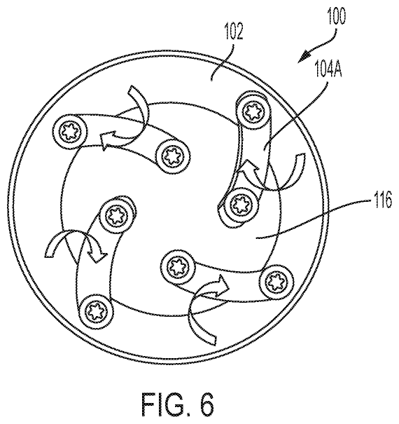

FIG. 6 shows an example clamp assembly 100 without the workpiece W in the center, with the movable fingers 104A-104D oriented radially inward (i.e., extending) into the opening 116 according to some embodiments. As shown, the arrows suggest how the movable fingers 104A-104D move relative to the base 102. In some instances, the movable fingers 104A-104D can be rotated at least 45 degrees with respect to the base 102. In other instances, the movable fingers 104A-104D can be rotated up to 180 degrees with respect to the base 102. The amount of rotation of the movable fingers 104A-104D may depend on the size and shape of the workpiece W being clamped to the movable fingers 104A-104D.

FIG. 7 shows an example clamp assembly 100 with the movable fingers 104A-104D aligned closely with the raised lip 118 of the base 102, according to some embodiments.

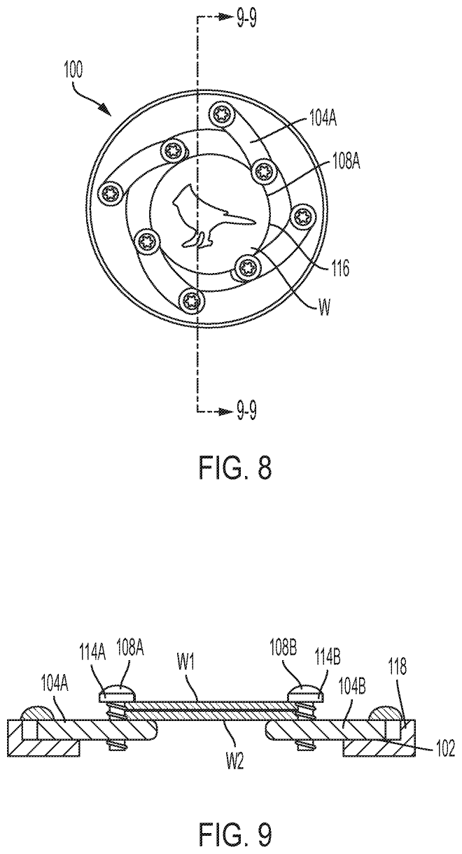

FIG. 8 shows an example clamp assembly 100 with a workpiece W with a pattern sawed out removably attached to the clamp assembly 100, according to some embodiments. As shown, the overlap between the first movable finger 104A and the base 102 is enhanced due to the similarity in radius and curvature, so that the base 102 provides more support for the movable finger 104A.

FIG. 9 shows a cross section of an example clamp assembly 100 with two workpieces W1-W2 clamped to the movable fingers 104A-104B, according to some embodiments. In the illustrated embodiment, the raised lip 118 has the same height as the movable fingers 104A-104B. In some instances, the raised lip 118 can be higher or lower than the movable fingers 104A-104B. The friction enhancing members 114A-114B are placed in between the edge fasteners 108A-108B and the workpieces W1-W2 in the illustrated embodiment. In other instances, the friction enhancing members 114A-114B may be placed in between the movable fingers 104A-104B and the workpieces W1-W2. In addition, there may be more than one friction enhancing member on each movable finger 104A-104D. For instance, in addition to the friction enhancing member 114A shown in FIG. 9, an additional friction enhancing member could be placed between the workpiece W2 and the movable finger 104A for friction enhancement.

After the two workpieces W1 and W2 are clamped to the movable fingers 104A-104D (e.g., between the movable fingers 104A-104B and the edge fasteners 108A-108B), a pattern may be sawed out simultaneously on the two workpieces W1 and W2. The patterns sawed out or formed on the two workpieces W1 and W2 are substantially similar to each other. In some instances, more than two workpieces can be clamped to the clamp assembly 100, forming substantially identical patterns to more than two workpieces.

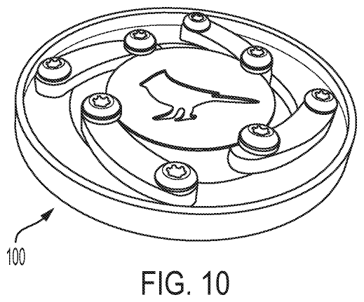

FIG. 10 is an isometric view of the clamp assembly 100 and workpieces W1 and W2 shown in FIG. 8, according to some embodiments.

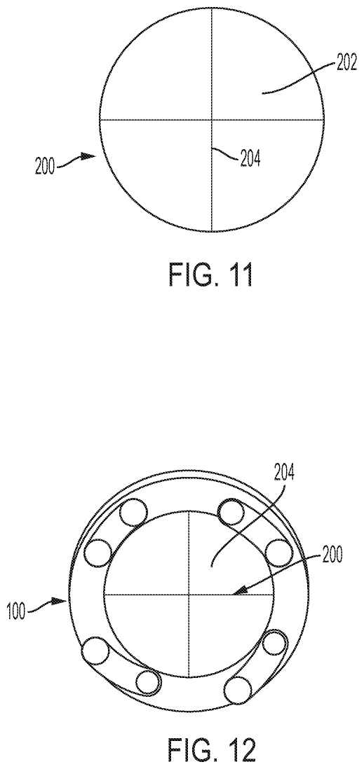

FIG. 11 illustrates a centering tool 200 that can be used in connection with the clamp assembly 100. In the illustrated embodiment, the centering tool 200 includes a base member 202 and indicia 204 on the base member. The base member 202 is sized and shaped to fit and register within the opening 116 of the clamp assembly 100. Indicia 204 (shown as intersecting lines in the illustrated embodiment) is located on the base member 202 at a position that will identify generally a center of the opening 116 of the clamp assembly 100 when the base member is mated with the opening of the clamp assembly. FIG. 12 is an illustration of the centering tool 200 located in the opening 116 of the clamp assembly 100. During use of the clamp assembly 100, a user can use the indicia 204 as a guide to locate workpieces such as W1-W2 within the base 102 when clamping the workpieces to the movable fingers 104A-104D. The centering tool 200 can be removed from the clamp assembly 100 before work on the workpiece W begins.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What is claimed is:

1. A clamp assembly, comprising:
a base defining an opening, wherein a workpiece can be positioned in the opening;
a plurality of movable fingers including first and second opposite end portions, wherein the first end portion of each movable finger is adjustably coupled to the base such that the movable finger is angularly adjustable relative to the base and capable of extending into the opening; and
an edge fastener coupled to the second end portion of each movable finger, wherein the edge fastener is configured to releasably engage the workpiece in the opening.

2. The clamp assembly of claim 1, wherein each movable finger is substantially similar in size and shape.

3. The clamp assembly of claim 2, wherein the base is annular in shape.

4. The clamp assembly of claim 1, wherein each movable finger is arcuate in shape.

5. The clamp assembly of claim 1, wherein each edge fastener is adjustably attached to the associated movable finger for movement between a clamping position and a released position.

6. The clamp assembly of claim 5, wherein each edge fastener is threadedly attached to the associated movable finger.

7. The clamp assembly of claim 6 wherein each edge fastener includes a friction enhancing member configured to enhance engagement with the workpiece.

8. The clamp assembly of claim 1, further including a plurality of friction enhancing members, wherein each friction enhancing member is associated with one of the movable fingers and is configured to enhance engagement between the movable finger and the workpiece.

9. The clamp assembly of claim 1, including at least three movable fingers.

10. The clamp assembly of claim 1, wherein each movable finger is configured to project radially into the opening relative to the base, and to be rotated at least 45 degrees with respect to the base.

11. A clamp assembly, comprising:
an annular base defining an opening, wherein a workpiece can be positioned in the opening;
at least three movable fingers having first and second opposite end portions, wherein each of the movable fingers has substantially the same size and shape;
a plurality of first finger fasteners, each first finger fastener pivotally coupling the first end portion of one of the movable fingers to the base to enable movement of the movable finger in the opening, and wherein the first end portions of the movable fingers are equidistantly spaced from one another; and
a plurality of edge fasteners, each edge fastener coupled to the second end portion of one of the movable fingers and configured for movement between a clamping position and a release position.

12. The clamp assembly of claim 11 wherein each movable finger is arcuate and has a radius of curvature substantially similar to a radius of curvature of the base.

13. The clamp assembly of claim 11 wherein the base and movable fingers are sized and shaped to enable each of the movable fingers to overlay the base in a retracted position.

14. The clamp assembly of claim 13 wherein each movable finger is arcuate and has a radius of curvature substantially similar to a radius of curvature of the base.

15. The clamp assembly of claim 14 and further including a lip extending from a side of the base opposite the opening, wherein the lip prevents movement of the movable fingers beyond the base.

16. The clamp assembly of claim 11 wherein the edge fasteners are threadedly attached to the movable fingers for movement between the clamping and release positions.

17. The clamp assembly of claim 11 and further including a plurality of friction enhancing members, wherein each friction enhancing member is associated with one of the movable fingers and is configured to enhance engagement between the movable finger and the workpiece.

18. The clamp assembly of claim 11 and further including a lip extending from a side of the base opposite the opening.

19. A method of patterning one or more workpieces using a clamp assembly including a frame defining an opening and a plurality of movable fingers extending from the frame into the opening, comprising:
positioning the one or more workpieces in the opening of a frame;
pivoting the movable fingers into engagement with the one or more workpieces;
clamping the one or more workpieces to the movable fingers; and
forming a pattern on the one or more workpieces while the one or more workpieces are clamped to the clamping assembly.

20. The method of claim 19 wherein:
the method further includes positioning a positioning guide in the opening of the frame; and
positioning the one or more workpieces includes positioning the one or more workpieces using the positioning guide before clamping the one or more workpieces to the movable fingers.
